(19) United States
(12) Patent Application Publication
(10) Pub. No.: US 2002/0095781 A1
(43) Pub. Date: Jul. 25, 2002

(54) Device for the feed of functional parts, especially fasteners, into components and a supply unit for one such device

(76) Inventor: Heiko Schmidt, Regensburg (DE)

Correspondence Address: HOFFMAN, WASSON & GITLER, PC, Suite 522, 2361 Jefferson Davis Highway, Arlington, VA, 22202, US

(21) Appl. No.: 10/050,149

(22) Filed: Jan. 18, 2002

(30) Foreign Application Priority Data
Jan. 19, 2001 (DE) 201 01 062.3

(51) Int. Cl. B23P 19/00

(52) U.S. Cl. 29/818; 29/809; 29/798

(57) ABSTRACT

A device for fastening functional parts in a component produced from a flat material, preferably sheet metal, by insertion and pressing, having several punching heads and opposing tool surfaces assigned to them. The component is located between the punching head and the pertinent opposing tool surface when the functional part is inserted. There are punching heads on a first tool part. The opposing tool surfaces are formed by thrust bearings which are provided on the top of a second plate-shaped tool part. The tool parts can be moved relative to one another for opening and closing the tool or the device and there are centering/guide and locking devices acting directly between the tool parts. When the tool parts are closed, the tool parts are directly centered and locked to one another. Each punching head is provided with an individual drive.

### BACKGROUND OF THE INVENTION

1. Field of the Invention

The invention relates to a device for feeding fastening functional parts to a component including a supply unit for the feeding of the functional parts.

2. Description of the Prior Art

“Functional parts” in the sense of the invention are in general elements, for example fasteners (for example, pins, rivets, nuts) which are fed into components. The feed of the fasteners, for example, pins, bolts and nuts into components or machined parts of sheet metal using so-called punching heads is knows as described in German Patent DE 43 43 154 A1.

### SUMMARY OF THE INVENTION

The object of the invention is to devise a device which, with a simplified structure, enables the feed, especially the simultaneous feed of several functional parts, specifically preferably a machined sheet metal part.

The object of the invention is furthermore to devise a supply unit which, with a simplified structure, several machine components, for example, punching heads, can be supplied with the pertinent functional parts (for example, fasteners).

By means of a centering and/or a guiding and/or locking device, in the device of the present invention, two tool parts which bear the punching heads and the pertinent thrust bearings, with the tool closed, are centered exactly to one another. These two tool parts are also connected by interlocking to one another such that the forces produced by the punching heads, when the functional parts are fed into the respective component, are completely accommodated between these tool parts and thus no forces are transferred to the outer elements of the device which bear the tool.

The multiple feed limitations of the present invention have the advantage that with a simple structure, it would allow for the supply of several components, for example, punching heads, via their own delivery sections or supply tubes with the same functional parts. It would also allow the selection and feed of functional parts in the required correct orientation from a disordered set, utilizing only a single supply device, for example, a single spiral cup conveyor.

### BRIEF DESCRIPTION OF THE DRAWINGS

The present invention will be explained below using the following figures.

FIG. 1 is a very simplified schematic of the fundamental structure of the device of the present invention;

FIG. 2 is in a perspective representation of one embodiment of the present invention showing the upper plate-shaped tool part of the device of FIG. 1;

FIG. 3 is in a perspective representation of one embodiment of the present invention showing the lower plate-shaped tool part of the device from FIG. 1;

FIG. 4 is in an enlarged partial representation of the present invention including a section of a workpiece produced form sheet metal with a fastener anchored in this workpiece in the form of a nut, together with a simplified partial representation of a punching head and its pertinent support;

FIG. 5 is a simplified representation of a device for the separation and parallel feed of fasteners to several components, for example, punching heads;

FIG. 6 is in an enlarged detailed representation of the multiple feed limitation of the device shown in FIG. 5; and

FIG. 7 is another embodiment of the multiple feed limitation in a representation similar to what is shown in FIG. 6.

### DETAILED DESCRIPTION OF THE PREFERRED EMBODIMENT

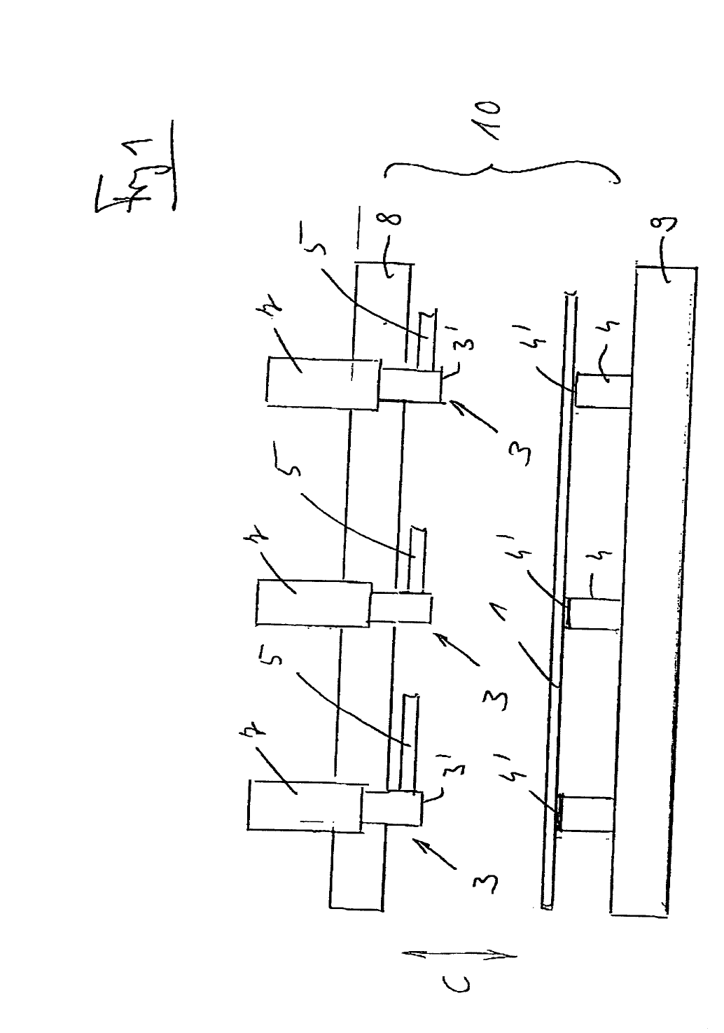

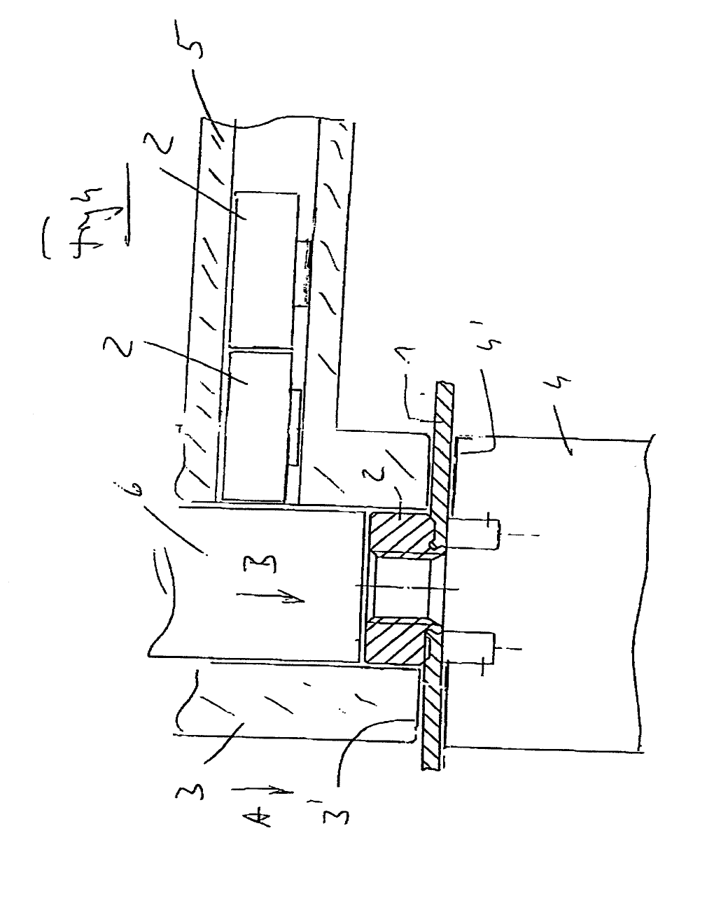

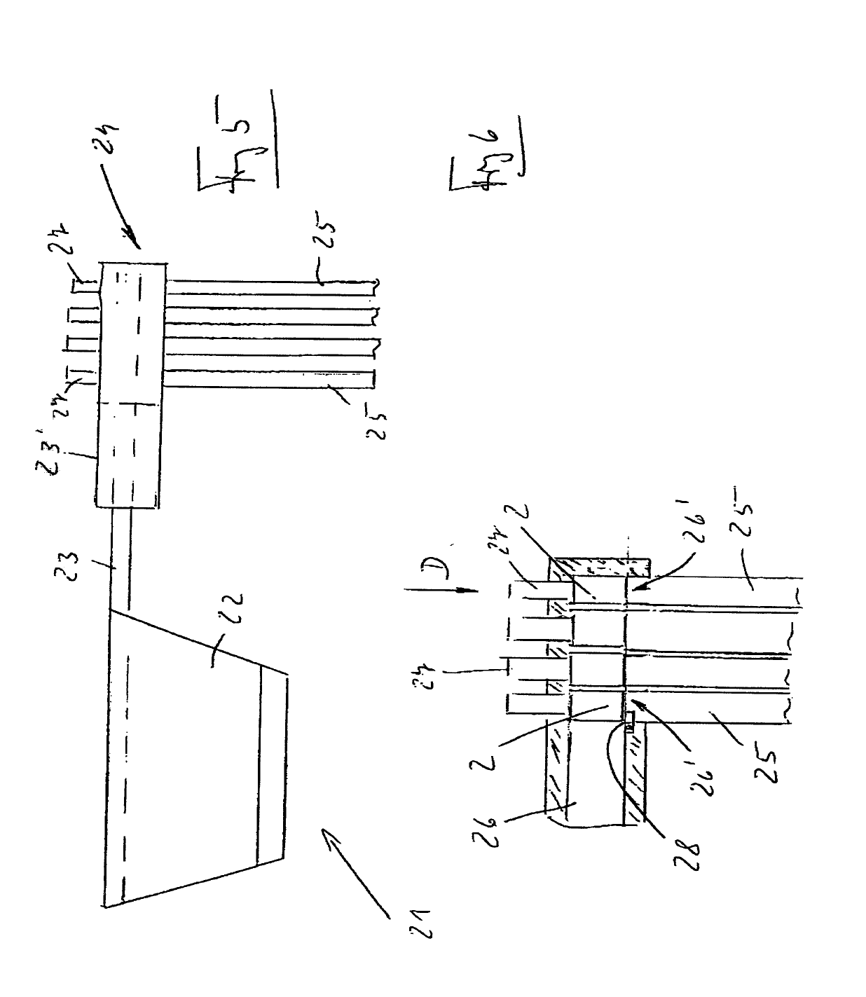

The device, shown in general in FIGS. 1-4, is used in workpieces or machined sheet metal parts 1 to anchor fasteners 2 which in the embodiment shown are nuts, by insertion into prepared openings of the machined parts 1 and by subsequent pressing. The insertion and pressing of the fasteners 2 take place using punching heads 3 which are known in their execution and function to one skilled in the art (for example, German Patent DE 43 43 154 A1) and using a thrust bearing 4. As is shown in FIG. 4, the fasteners 2 are provided in the guide 5 of the punching head. In each pass, the first fastener 2 in line is fed into the machined part 1 by means of a plunger 6 of the punching head 3 which, with its bottom or with an annular surface 3′ rests against the top of the machined part 1. Then, by moving the punching head 3 down, the fastener 2 is anchored by pressing or deforming the material of the machined part 1 between the annular surface 3′ and the thrust bearing 4 in the machined part 3. The fasteners 2 are fed to the respective punching head 3 or to the guide 5 by, for example, via a supply unit as in shown in FIG. 5.

In the device, there are punching heads 3 with their pertinent drives 7 which are formed, for example, by hydraulic cylinders on the plate-shaped top part 8 of a tool 10, where a fastener 2 is to be fed to the machined part 1. The thrust bearings 4 are located on the top of the plate-shaped tool bottom part 9, such that one thrust bearing 4 is opposite each punching head 3. The top part 8 of the tool and the bottom part 9 of the tool are located in a press which is not shown. The bottom part 9 of the tool is stationary and the top part 8 of the tool can be moved by the opening and closing of the tool 10 which is formed by the two tool parts 8 and 9 perpendicular to its plate planes away from and towards the tool part 9.

As is shown in FIG. 1, the machined part 1, after insertion into the tool 10, lies essentially only on the thrust bearing 4 or on the opposing surface 4′ and possibly also on support elements which are not shown. After closing the tool 10, the above-described feed and anchoring of the fasteners 2 into the component 1 by means of the punching heads 3 would then take place.

The operation of the tool 10 has the advantage that in one pass, a host of fasteners 2 can be fed to the machined part 1 and/or attachment of the fasteners 2 is possible such that these fasteners 2 are oriented with their axes in different axial directions, and then also the punching heads 3 and the pertinent opposing surface 4′ can have an orientation which differs from punching head to punching head, and which corresponds to the respective orientation of the fasteners 2.

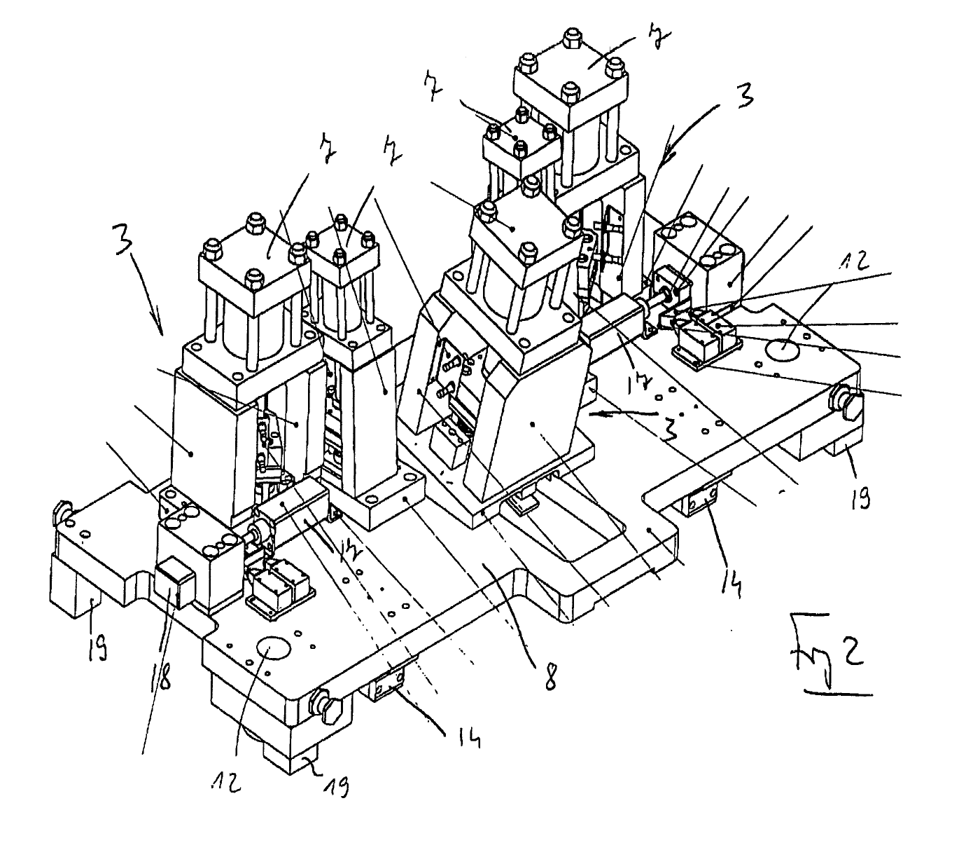

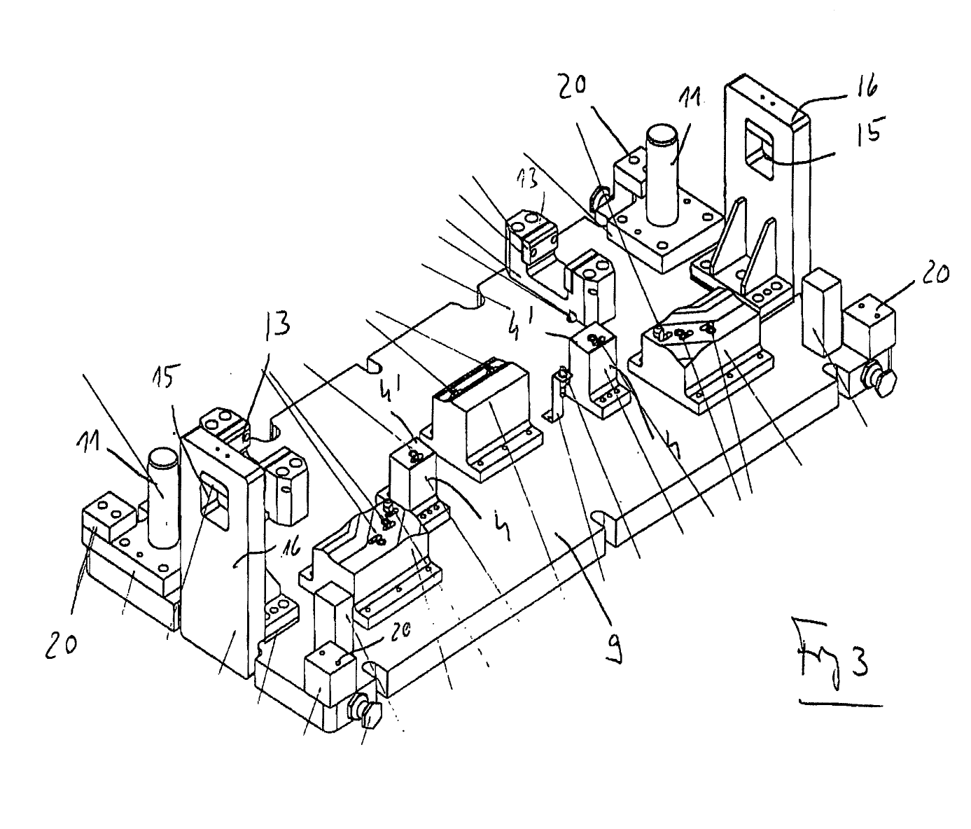

As shown particularly in FIGS. 2 and 3, on the top of the bottom part 9 of the tool there are centering pins 11 which, when the tool 10 is closed, fit into centering openings 12 in the top part 8. Furthermore, on the surface of the bottom part 9 of the tool there are fork-shaped guide pieces 13 into which, with the tool 10 closed, guide elements 14 which project from the bottom of the top part 8 of the tool, fit by interlocking, with one another. Therefore, when the tool is closed, the tool parts 8 and 9 are also connected to one another by interlocking for the transfer of horizontal force components which are produced by the punching heads 3 which are tilted to the vertical.

On the bottom part 9 of the tool, there are furthermore included locking brackets 16 which have locking openings 15 and which interact with bolts 18 which are actuated by actuators 17 (for example, hydraulic cylinders) such that with the tool 10 is closed, one bolt 18 at a time fits into each locking opening 15 and thus the two tool parts 8 and 9 are locked to one another and are secured against one another against opening of the tool 10.

In particular therefore, the upper tool part 8, after inserting the machined part 1 using a press which is not shown, is moved down and in doing so, centered and guided first on the centering pins 11 which fit into the centering openings 12 until finally the guide pieces 14 engage the fork-shaped guide piece 13 and spacer elements 19 which are provided on the bottom of the top part 8, and project over this bottom portion, come to rest against the corresponding spacers 20 of the bottom part 9 of the tool. Therefore, the top part 8 of the tool occupies a defined lower position to the tool part 9. Activating the actuating elements 17 then locks the bolts 18 in the locking openings 15. Subsequently, by actuating the drives 7, the above-described feed and affixing of the fasteners 2 in the machined part 1 take place.

To feed the fasteners to the different punching heads 3, a supply unit 21 shown schematically in FIG. 5 is used. This embodiment essentially comprises an oscillating cup conveyor 22 which holds the fasteners in a disordered set and which conveys these fasteners in a given orientation to a guide rail 23 in which the fasteners 2 finally reach the feed limitation 24 via a lock 23′ which opens the guide 23 only for passage of the fasteners and otherwise blocks it again. The feed limitation in this embodiment has a total of four outputs to which one conveyor section formed by one flexible tube 23 at a time is connected for the fasteners 2. The cross section of each conveyor section 25 is chosen such that the fasteners 2 are conveyed along this conveyor section while retaining a given orientation, in the embodiment shown, by a compressed air pulse. The conveyor sections 25 each lead to one punching head or to the pertinent rigid guide rail 5 of this punching head.

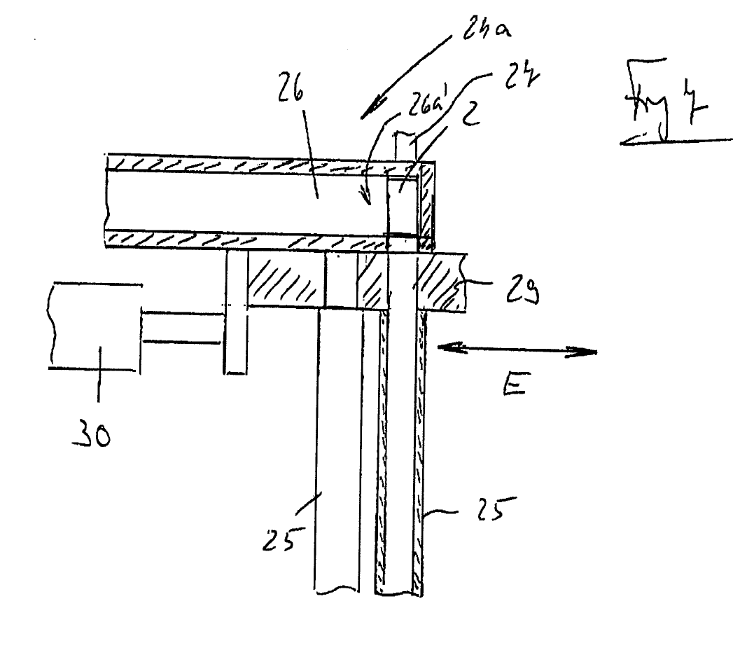

FIG. 6 shows the feed limitation 24 in more detail. It consists essentially of a receiving channel 26 which is formed by the continuation of the guide 23 and in which four fasteners 2 tightly adjoining one another are accommodated in a given orientation. On one side of this channel 26 there are electrically triggerable pressure nozzle arrangements 27, one nozzle arrangement 27 at a time fro each section 26′ of the channel 26 occupied by the fastener 2. Opposite the pressure nozzle arrangement 27 is the inlet opening or the connection of the conveyor feed section 25 so that upon activation of the pertinent nozzle arrangement 27 by the compressed air pulse, which is indicated by the arrow D, and which radially enters the channel 26 from this nozzle arrangement, the pertinent fastener 2 is closed from its position in the channel 26 into the supply tube 25 and via the latter to the pertinent punching head 3 or another component.

The manner of operation of the feed limitation will now be described. The initially empty channel 26 is charged with the number of fasteners 2 which corresponds to the selection positions by supplying these fasteners 2 via the guide 23 and the lock 23′. After complete charging of the channel 26, either a simultaneous injection of the fasteners 2 into the pertinent supply tubes 25 or injection in a timed succession would occur.

Wherever the channel 26 discharges into a supply tube 25, an elastic catch 28 is provided. These catches 28 are made such that when the channel 26 is charged, they prevent the unwanted entry of the fasteners 2 into the supply tubes 25, i.e., they block the supply tubes from the fasteners 2. Only when the nozzle elements 27 are actuated, are the fasteners 2 injected into the supply tubes 25, as the catches 28 press from overhead.

FIG. 7 shows as another possible embodiment, a supply unit, which differs from the supply unit 21 in that the fasteners 2 are injected into the supply tubes 25 in timed succession. There is a charging channel 26a for this purpose which has only one position 26a′ for holding one fastener 2, at which position in turn there is the electrically controllable nozzle arrangement 27. Opposite the nozzle arrangement 27, there is a slider 29 which can be moved by a drive 30 axially to the channel (double arrow E) and on which in the direction E of motion in succession there are openings or connections for the supply tubes 25. In each position of the slider 29, there is one opening of the supply tube 25 in the area of the charging position 26a′, opposite the pressure nozzle arrangement 27 so that, by activating the nozzle arrangement 27, the pertinent fastener 2 can be delivered via the supply tube 25 to the pertinent component, for example, to the pertinent punching head 3.

The fasteners 2 are located in this version, for example, in a closed row in which the fasteners 2 tightly adjoin one another arranged in the channel 26a, the first fastener 2 of this row, via the slider 29, entering the pertinent supply tube 25 and to reach the pertinent component.

The invention was described above using embodiments. It goes without saying that numerous changes and modifications are possible without departing from the inventive idea underlying the invention.

What is claimed is:

1. A device for fastening functional parts into a flat workpiece, preferably constructed from sheet metal, by insertion and pressing with a plurality of punching heads and opposed tool surfaces, comprising:
a first tool part provided with the plurality of punching heads, each having an individual drive member, said first tool part provided with a top centering device, a top guide device and a top locking device; and
a second tool part provided with a bottom centering device, a bottom guide device and a bottom locking device;
wherein, said first and second tool parts move relative to one another to close the device with the flat workpiece therebetween, and further wherein, when the device is closed, said top and bottom centering devices are mated, said top and bottom guide devices are mated and said top and bottom locking devices are mated.

2. The device as claimed in claim 1, wherein said first tool part and/or said second tool part are each plate-shaped.

3. The device as claimed in claim 1, further including thrust bearings provided on said second tool part projecting over the top of said second tool part.

4. The device as claimed in claim 1, wherein at least one of the punching heads is in the axial direction which includes an angle with the axis of the closing and opening motion of the device.

5. The device as claimed in claim 1, wherein one of said tool parts is securely located on the frame of a press and the other of said tool parts is located on the movable part of the press, which executes the press stroke.

6. The device as claimed in claim 1, wherein said top centering device comprises at least one opening and said bottom centering device comprises at least one centering pin.

7. The device as claimed in claim 1, wherein said top guide device and said bottom guide devices comprise interfitting guide pieces.

8. The device as claimed in claim 1, wherein said top and bottom locking devices include at least one motorized bolt and at least one bolt opening.

9. The device as claimed in claim 1, further including a supply unit including supply tubes for the functional parts, and wherein the punching heads are connected to said supply unit by said supply tubes.

10. The device as claimed in claim 9, wherein said supply unit comprises a feed limitation for the functional parts to which said supply tubes are connected.

11. The device as claimed in claim 10, wherein said feed limitation comprises a charging channel which in the lengthwise direction of said channel has a plurality of separation and charging positions for receiving one functional part at a time, wherein there is a connection for each of said supply tubes at each charging position, and further including feeding means for feeding the functional part which is at the charging position via said supply tube connection into one supply tube and for conveying the functional part along said supply tube to one of the punching heads.

12. The device as claimed in claim 11, wherein said feed limitation has a charging channel to which the functional parts are supplied in the direction which forms a charging position and wherein at the charging position a supply tube connection carrier is provided having several connections which are each joined to one of said supply tubes, and with which selectively one connection at a time can be joined to one of said charging positions, and wherein said feeding means feeds the functional part at one of said charging positions into one of said supply tubes, which is joined to one of said charging positions and for continued motion into said supply tube.

13. The device as claimed in claim 12, wherein said supply tube connection carrier is a slider.

14. The device as claimed in claim 12, further including a drive means for moving said supply tube connection carrier.

15. The device as claimed in claim 12, wherein said feeding means for feeding the respective functional part into said supply tube and for conveying the functional part along said supply tube is formed by at least one controllable nozzle with a pressurized fluid emerging from said nozzle, such as compressed gas or compressed air.

16. The device as claimed in claim 12, wherein said connection for said supply tubes is on one lengthwise side of said charging channel.

17. The device as claimed in claim 11, further including a pressure nozzle on said charging channel opposite each connection of said supply channels.

18. A supply unit for feeding functional parts, especially fasteners to several components, such as punching heads via separate supply sections or supply tubes, wherein the supply unit comprises a feed limitation for the functional parts connected to the supply tubes.

19. The supply unit as claimed in claim 18, wherein said feed limitation is provided with a charging channel which in the lengthwise direction of the channel has in succession separation and charging positions for receiving one functional part at a time, wherein a connection for the supply tube at each charging position is provided and further included a feeding means for feeding the functional part provided at the charging position via a supply tube connection into one of the supply tubes and for conveying the functional part along that supply tube to one of the punching heads.

20. The supply unit as claimed in claim 19, wherein said feed limitation is provided with a charging channel to which the functional parts are supplied in the conveyor direction and which forms a charging position, and wherein at the charging position a supply tube connection carrier is provided having a plurality of connections which are each joined to one of said supply tubes, and with which selectively one connection at a time can be joined to said charging position, and wherein said feeding means for feeding the functional part is provided at the charging position into one of said supply tubes which is joined to said charging position for continued motion in this supply tube.

21. The supply unit as claimed in claim 20, wherein the supply tube connection carrier is a slider.

22. The supply unit as claimed in claim 20, further including a drive means for moving said supply tube connection carrier.

23. The supply unit as claimed in claim 20, wherein said feeding means for feeding the respective functional part into the supply tube and for conveying it along the supply tube is formed by at least one controllable nozzle for a pressurized fluid emerging from this nozzle, such as compressed gas or compressed air.

24. The supply unit as claimed in claim 19, wherein said connections for said supply tubes are on one lengthwise side of said charging channel.

25. The supply unit as claimed in claim 23, wherein there is said pressure nozzle on said charging channel is provided opposite each connection of said supply tube.
